(19) United States
(12) Patent Application Publication
(10) Pub. No.: US 2017/0067622 A1
(43) Pub. Date: Mar. 9, 2017

(54) Monolithic Base Of LED Lighting Module And Lamp Having The Same

(71) Applicant: Everlight Electronics Co., Ltd., New Taipei City (TW)

(72) Inventors: Tzu-Hao Chao, New Taipei City (TW); Shun-Chang Li, New Taipei City (US); Ching-Yun Ma, New Taipei City (TW)

(21) Appl. No.: 14/847,440

(22) Filed: Sep. 8, 2015

(51) Int. Cl. F21V 19/00; F21K 99/00; F21V 17/12; F21V 1/00; F21V 29/77; F21V 23/00

(52) U.S. Cl. CPC F21V 19/006; F21V 29/777; F21V 23/005; F21V 17/12; F21V 1/00; F21K 9/1355; F21Y 2101/02

(57) ABSTRACT

Various examples of an LED lighting module and a lamp having the LED lighting module are described. An LED lighting module may include an LED lighting member, configured to emit light and including at least one LED, and a monolithic base that is substantially cylindrically shaped with a cavity therein. The monolithic base may include a first distal end, a second distal end opposite the first distal end, a top surface located at the first distal end and including a hole intercommunicating with the cavity, and an exterior surface disposed between the first and the second distal ends. The LED lighting member may be disposed on the top surface. The exterior surface may include one or more screw threads thereon.

### TECHNICAL FIELD

The present disclosure relates to luminaires and, more particularly, to a monolithic base of a LED lighting module and a lamp having the monolithic base of the LED lighting module.

### BACKGROUND

Light-emitting diodes (LEDs) have many benefits such as long useful life, compact size, high shock resistance, low heat generation and low power consumption. As a result LEDs have been widely adopted in applications including household appliances as well as indicators and light sources of various types of equipment. In the future, it is possible for LEDs to become the mainstream lighting sources with both energy saving and environment-friendly features. To help expedite market adoption of LED-based lamps, it is imperative to lower either or both of the manufacturing cost and transportation cost associated with new designs of LED-based lamps. It would also help if the assembly and/or installation of LED-based lamps could be simplified.

### SUMMARY

The present disclosure describes various implementations of a monolithic base of a LED lighting module and a lamp having the LED lighting module. Numerous benefits are provided by implementations in accordance with the present disclosure. Firstly, one benefit of implementing features of the present disclosure in a lamp is that the total number of components of the lamp is reduced and hence less than that of a conventional lamp. Additionally, the manufacturing cost for a lamp in accordance with the present disclosure tends to be lower than that for a conventional lamp. Moreover, the transportation cost for a lamp in accordance with the present disclosure tends to be lower than that for a conventional lamp. Furthermore, for an end user the assembly of a lamp in accordance with the present disclosure tends to be easier than the assembly of a conventional lamp.

In one aspect, an LED lighting module may include an LED lighting member, configured to emit light and comprising at least one LED, and a monolithic base that is substantially cylindrically shaped with a cavity therein. The monolithic base may include a first distal end, a second distal end opposite the first distal end, a top surface located at the first distal end and including a hole intercommunicating with the cavity, and an exterior surface disposed between the first and the second distal ends. The LED lighting member may be disposed on the top surface. The exterior surface may include one or more screw threads thereon.

In some implementations, the monolithic base may be made of metal or ceramic.

In some implementations, the exterior surface of the monolithic base may further include a plurality of fins configured to dissipate heat from the monolithic base. The one or more screw threads may be disposed near the first distal end and the plurality of fins are disposed near the second distal end.

In some implementations, the one or more screw threads on the exterior surface are disposed near the first distal end or across the exterior surface between the first distal end and the second distal end of the monolithic base.

In some implementations, the LED lighting member may further include a driver-on-board (DOB) including a board and a driver circuit. The at least one LED and the driver circuit may be disposed on the board. The driver circuit may be configured to drive the at least one LED.

In some implementations, the LED lighting module may further include a holder disposed between the DOB and the top surface of the monolithic base. The holder may be made of an electrically-insulating material.

In some implementations, the holder may further include a through hole, wherein the through hole of the holder, the hole of the monolithic base and the cavity of the monolithic base may be configured to accommodate one or more electrical components configured to supply an electrical power to the driver circuit at the DOB and the at least one LED.

In some implementations, the LED lighting module may also include a lamp cover mounted on the first distal end of the monolithic base.

In some implementations, the LED lighting module may also include a lamp cover mounted on the holder.

In some implementations, each of the lamp cover and the holder may respectively include at least one screw thread or groove. The at least one screw thread or groove of the lamp cover may be configured to engage with the at least one screw thread or groove of the holder.

In some implementations, the LED lighting module may also include a locking cap and a lamp cover, wherein the locking cap is disposed on the holder. The locking cap is configured to prevent a user from touching the driver circuit of the DOB in assembling the lamp cover onto the holder. For an ideal lighting effect, the locking cap is preferably made of transparent material or any other materials that the light can pass through.

In some implementations, the locking cap may include one or more mating threads or grooves, wherein the one or more mating threads or grooves disposed on the locking cap may be respectively configured to engage with one or more screw threads or grooves on the holder and one or more screw threads or grooves on the lamp cover.

In another aspect, a lamp may include an LED lighting module which may include an LED lighting member and a monolithic base. The LED lighting member may be configured to emit light and including at least one LED. The monolithic base may be substantially cylindrically shaped with a cavity therein. The monolithic base may include a first distal end, a second distal end opposite the first distal end, a top surface located at the first distal end and including a hole intercommunicating with the cavity, and an exterior surface disposed between the first and the second distal ends and comprising one or more screw threads thereon. The LED lighting member may be disposed on the top surface of the monolithic base. The lamp may also include a lampshade including an accommodating space. The accommodating space may be adapted to accommodate the LED lighting module.

In some implementations, the lampshade may further include a bottom surface and a perforation penetrating through the bottom surface. The perforation may be adapted to allow the LED lighting module to pass through therein and to be accommodated in the accommodating space.

In some implementations, the monolithic base may be made of metal or ceramic.

In some implementations, the one or more screw threads of the exterior surface may be disposed near the first distal end or across the exterior surface between the first distal end and the second distal end of the monolithic base.

In some implementations, the LED lighting member may further include a driver-on-board (DOB) which may include a board and a driver circuit. The at least one LED and the driver circuit may be disposed on the board. The driver circuit may be configured to drive the at least one LED.

In some implementations, the LED lighting module may further include a holder disposed between the DOB and the top surface of the monolithic base. The holder may be made of an electrically-insulating material. The LED lighting module may also include a lamp cover mounted on the holder.

This summary is provided to introduce concepts relating to an omnidirectional lamp. Some embodiments of the LED lighting module and the lamp are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is an exploded view of an LED lighting module in accordance with an embodiment of the present disclosure.

FIG. 1B is a perspective bottom view of the LED lighting module of FIG. 1A.

FIG. 1C is a perspective top view of the LED lighting module of FIG. 1A.

FIG. 2 is an exploded view of an LED lighting module in accordance with another embodiment of the present disclosure.

FIG. 3 is an exploded view of an LED lighting module in accordance with another embodiment of the present disclosure.

FIG. 4A is an exploded view of an LED lighting module in accordance with another embodiment of the present disclosure.

FIG. 4B is a perspective bottom view of the LED lighting module of FIG. 4A.

### DETAILED DESCRIPTION

### Overview

The present disclosure describes various implementations of a monolithic base utilized in a LED lighting module of a lamp. Traditionally a lamp is separate from a lamp holder to which the lamp may be screwed on. In contrast, the monolithic base, with one or more screw threads thereon, allows a lamp in accordance with the present disclosure to replace the combination of a conventional lamp and a conventional lamp holder. Consequently, the total number of components of the lamp in accordance with the present disclosure is reduced. This leads to lower manufacturing cost as well as lower transportation cost for a lamp in accordance with the present disclosure. In addition, from the perspective of an end user, the assembly of a lamp in accordance with the present disclosure tends to be easier than the assembly of a conventional lamp.

In general, an implementation in accordance with the present disclosure provides an LED lighting module that includes a monolithic base and a lamp cover disposed on the monolithic base. A profile of a side view of the lamp cover may be substantially shaped like a trapezoid, a bullet or a traditional light bulb. The monolithic base may include one or more screw threads that are disposed on an exterior surface of the monolithic base. Optionally, the one or more screw threads may be disposed across the exterior surface from a first distal end of the monolithic base to a second distal end of the monolithic base opposite the first distal end; or the one or more screw threads may be disposed on part of the exterior surface and near the first distal end of the monolithic base, wherein the monolithic base may also include fins disposed near the second distal end of the monolithic base.

Implementations in accordance with the present disclosure also include a lamp that includes a lampshade and an LED lighting module, which may be configured in accordance with any of the various implementations of the present disclosure.

### Example Implementations

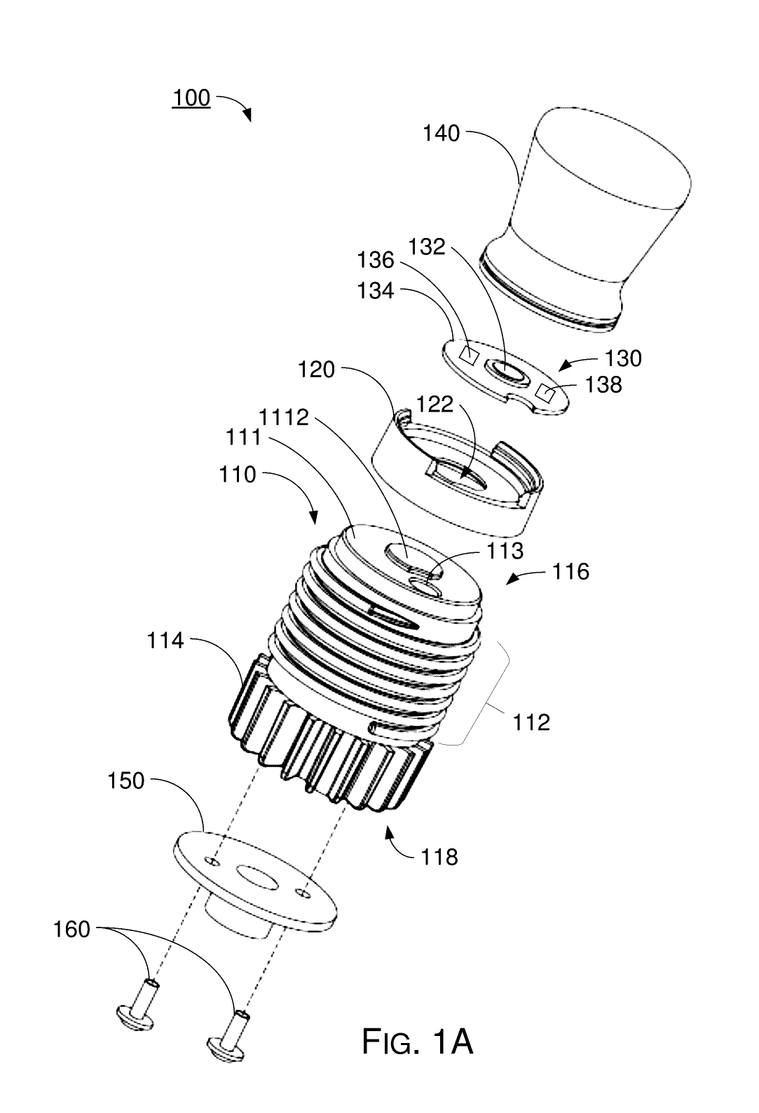

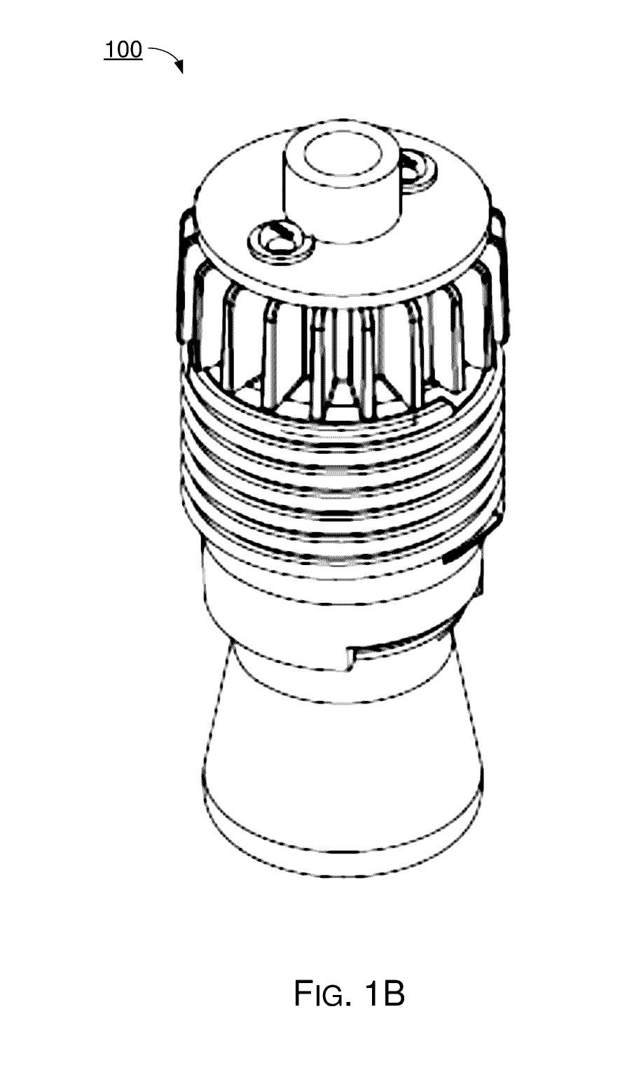

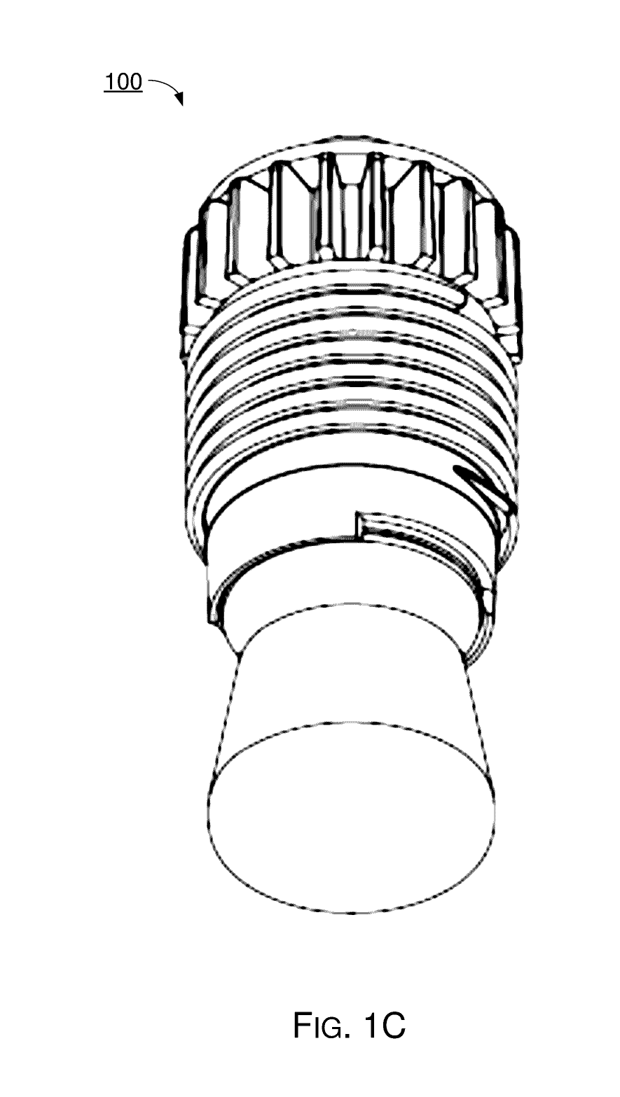

FIGS. 1A, 1B and 1C illustrate various views of an LED lighting module 100 in accordance with an embodiment of the present disclosure. The LED lighting module 100 may be a part of a lamp, and may include a monolithic base 110 and an LED lighting member 130. By “monolithic” it is meant that the monolithic base 110 is formed of a single block of material, e.g., fabricated from a single block of metal such as aluminum, aluminum alloy, tungsten or copper, as opposed to being formed of multiple discrete pieces of materials. The monolithic base 110 may be substantially cylindrically shaped with a cavity (not shown) therein. The monolithic base 110 may include a first distal end 116, a second distal end 118 opposite the first distal end 116, a top surface 111 located at the first distal end 116 and on which at least one light source 132 (e.g., LED) may be disposed, and an exterior surface between the first distal end 116 and the second distal end 118. The first distal end 116, e.g., the upward-pointing end of the monolithic base 110 as shown in FIG. 1, may be configured to receive the LED lighting member 130 that is configured to emit light and may include at least one light source (e.g., LED). The second distal end 118, e.g., the downward-pointing end of monolithic base 110 as shown in FIG. 1, may have an opening communicatively connected to the cavity of the monolithic base 110. The top surface 111 may include a hole 113 intercommunicating with the cavity. The exterior surface may include one or more screw threads 112 thereon. The exterior surface of the monolithic base 110 may also include, for example, a plurality of protrusions 114 thereon to dissipate heat from the monolithic base 110. In the example shown in FIGS. 1A, 1B, and 1C, the one or more screw threads 112 are disposed nearer or otherwise closer to the first distal end 116 of the monolithic base 110 than the protrusions 114, and the protrusions 114 are disposed nearer or otherwise closer to the second distal end 118 of the monolithic base 110 than the one or more screw threads 112.

In some implementations, the monolithic base 110 may be made of metal or ceramic. In some implementations, the protrusions 114 may include a plurality of fins, as shown in FIGS. 1A, 1B and 1C. The fins may be configured to dissipate heat from the monolithic base 110.

In addition, the LED lighting module 100 may also include a holder 120 configured to be disposed on the first distal end 116 of the monolithic base 110. The holder 120 may be made of an electrically-insulating material, e.g., plastic. The holder 120 may have a securing mechanism such as, for example, one or more grooves, latches and/or screw threads that allow a lamp cover to be secured onto the holder 120.

The LED lighting member 130 includes at least one light source 132, and may further include a driver-on-board (DOB) that may include a board 134 and a driver circuit 136, wherein the driver circuit 136 and the at least one light source 132 are disposed on the board 134, and the driver circuit 136 is coupled to drive the at least one light source 132. The board 134 of the DOB may be a printed circuit board (PCB), and may be made of ceramic or a composite material. With the DOB disposed on the holder 120, the holder 120 may provide a function that increases the overall length or height of the LED lighting module 100. In particular, to satisfy the safety regulations for certain markets including North America, the holder 120 allows the one or more light sources of the DOB to be away from the first distal end 116 of the monolithic base 110 by at least a minimum distance. In some implementations, the DOB can also be replaced by IC on die, IC on package, or driver that is not integrated on the board. In still some implementations, the at least one light source 132 may include one or more LEDs. The one or more LEDs may include LED chips, LED packages, chip scale package (CSP), flip chip LED, direct current (DC) LED, alternating current (AC) LED, high-voltage (HV) LED, chip on board (COB), filament LED, lamp LED, surface mount device (SMD) or the like. The LED lighting module 100 may further include a light distribution structure such as first optical lens, second optical lens, reflector, or molded lens so as to obtain a desired light distribution effect.

In other implementations, the monolithic base 110 may further have a protrusion part 1112 on the top surface 111, and the holder 120 may further have a hole 122 configured to received the protrusion part 1112. Part of the LED lighting member 130 disposed on the holder 120 may be in direct contact with the protrusion part 1112 of the monolithic base 110 to dissipate heat through the protrusion part 1112 of the monolithic base 110, and remainder part of the LED lighting member 130 may be in direct contact with the holder 120. For more details, part of the board 134 of the DOB of the LED lighting member 130 is in direct contact with the protrusion part 1112 of the monolithic base 110.

In some implementations, the LED lighting member 130 may also include a high-voltage protection circuit 138 on the board 134 which is configured to prevent an electrical voltage higher than a threshold voltage from being applied to the at least one light source 132, the driver circuit 136, or a combination thereof. This design feature provides a safety measure to prevent or at least minimize the hazard of electric shock when an end user is to assemble and/or install the LED lighting module 100.

In some implementations, the holder 120 may further include a through hole (not shown in FIG. 1A) corresponding to the hole 113 of the monolithic base 110, wherein the through hole of the holder 120, the cavity and the hole 113 of the monolithic base 110 are configured to accommodate one or more electrical components, e.g., electrical wires, configured to supply an electrical power from an external power source, e.g., AC mains, to drive the driver circuit 136 of the DOB and the one or more light sources 132 disposed on the board 134 of the DOB. In some embodiments, the LED lighting member 130 may also include a circuit (not shown) that converts the electrical power from alternating current (AC) to direct current (DC) for powering the driver circuit 136 of the DOB and the one or more light sources 132 disposed on the board 134 of the DOB.

In some implementations, the LED lighting module 100 may also include an end cap 150 configured to be disposed on the second distal end 118 of the monolithic base 110. In the example shown in FIG. 1A, one or more screws 160 may be provided to secure the end cap 150 onto the second distal end 118 of the monolithic base 110. The end cap 150 may include a cylindrical protrusion with internal threads that allow the end cap 150 (as well as the entire LED lighting module 100) to be screwed onto a fixture (not shown in FIG. 1A).

The LED lighting module 100 may also include a lamp cover 140 mounted on holder 120. Alternatively, in implementations without the holder 120, the lamp cover 140 may be mounted on the first distal end 116 of the monolithic base 110. In the example shown in FIGS. 1A, 1B and 1C, a profile of a side view of the lamp cover 140 may substantially resemble a trapezoid. The lamp cover 140 may be transparent or translucent such that light emitted by the one or more light sources 132 may transmit through the lamp cover 140. Alternatively, the lamp cover 140 may be shaped like a bulb or a bullet. Alternatively, the lamp cover 140 may include a mechanical feature configured to engage with the securing mechanism on the holder 120 when the lamp cover 140 is mounted on the holder 120.

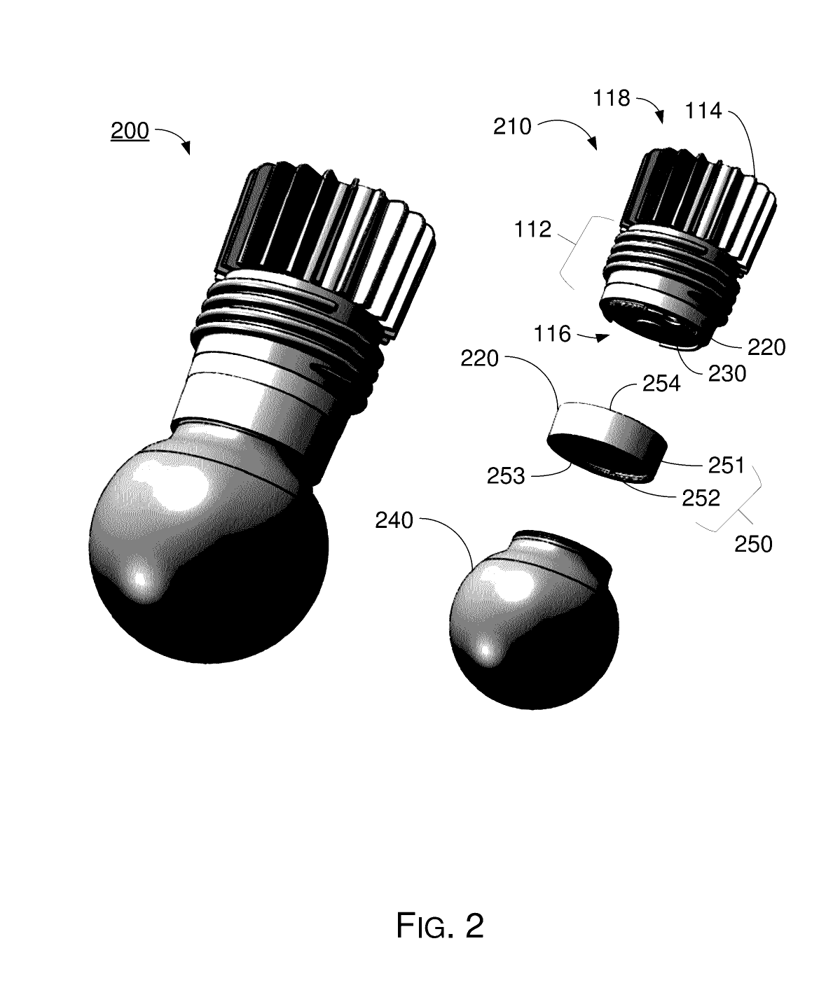

FIG. 2 illustrates an exploded view of an LED lighting module 200 in accordance with another embodiment of the present disclosure. The LED lighting module 200 may be a part of a lamp, and may include a monolithic base 210, a holder 220, an LED lighting member 230, a lamp cover 240 and a locking cap 250 disposed on the holder 220. The monolithic base 210 may be similar or identical to the monolithic base 110. The holder 220 may be similar or identical to the holder 120. The LED lighting member 230 may be similar or identical to the LED lighting member 130. Therefore, in the interest of brevity, detailed description of each of the monolithic base 210, the holder 220 and the LED lighting member 230 are not provided so as to avoid redundancy. One difference between the LED lighting module 200 and the LED lighting module 100 is that a profile of a side view of lamp cover 240 may be substantially shaped like a traditional light bulb. Another difference between the LED lighting module 200 and the LED lighting module 100 is that the LED lighting module 200 further includes the locking cap 250 disposed between the lamp cover 240 and the holder 220. For an ideal lighting effect, the locking cap 250 is preferably made of transparent material or any other materials that the light can pass through. In some implementations, the lamp cover 240 may be mounted on the locking cap 250. Alternatively, in implementations in which the LED lighting module 200 does not include the locking cap 250, the lamp cover 240 may be mounted on the holder 220 which is disposed on the first distal end of the monolithic base 210.

The above-mentioned locking cap 250 may include a transparent annular surface 251 and a transparent top surface 252 surrounded by the transparent annular surface 251. In some implementations, the locking cap 250 may include one or more mating threads respectively disposed on a first edge 253 and a second edge 254 opposite to the first edge 253 of the transparent annular surface 251. The transparent top surface 252 may be disposed between the first edge 253 and the second edge 254 of the transparent annular surface 251. The one or more mating threads disposed on the first edge 253 and on the second edge 254 of the locking cap 250 may be respectively configured to engage with one or more screw threads on the lamp cover 240 and one or more screw threads on the holder 220. Advantageously, the locking cap 250 may be configured to prevent a user from touching the driver circuit of the DOB of the LED lighting member 230 in assembling the lamp cover 240 onto the holder 220.

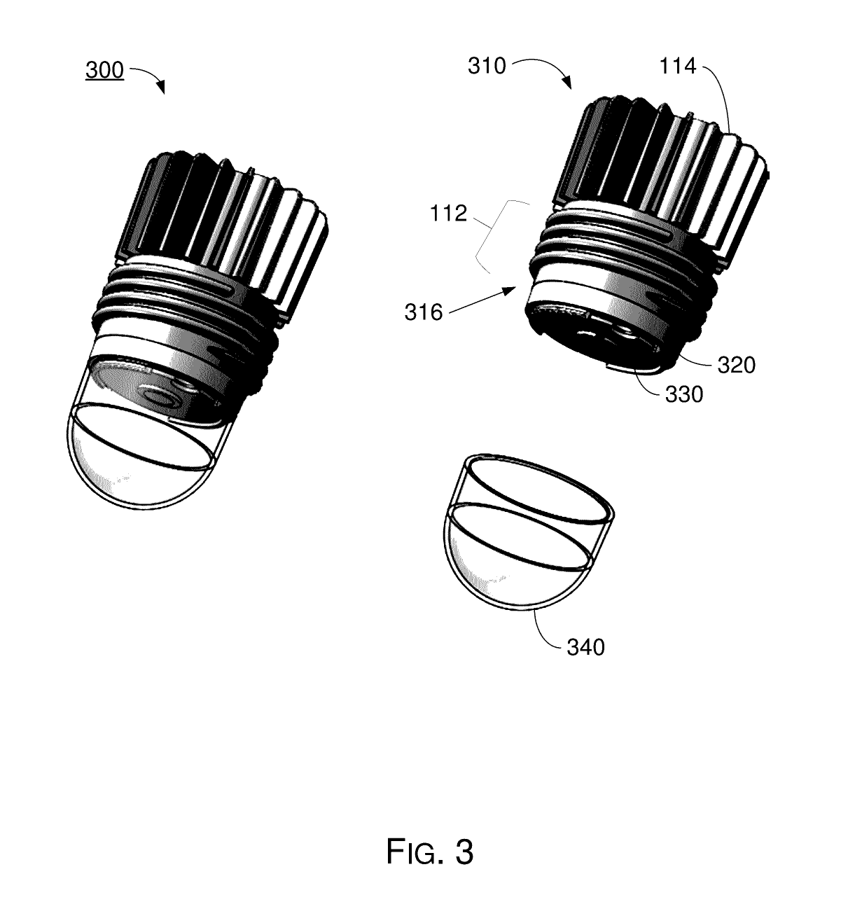

FIG. 3 illustrates an exploded view of an LED lighting module 300 in accordance with another embodiment of the present disclosure. The LED lighting module 300 may be a part of a lamp, and may include a monolithic base 310, a holder 320, an LED lighting member 330 and a lamp cover 340, wherein the lamp cover 340 is shaped like a bullet. Alternatively, the lamp cover 340 may be shaped like a traditional light bulb or a trapezoid. The monolithic base 310 may be similar or identical to the monolithic base 110. The holder 320 may be similar or identical to the holder 120. The LED lighting member 330 may be similar or identical to the LED lighting member 130. Therefore, in the interest of brevity, detailed description of each of the monolithic base 310, the holder 320 and the LED lighting member 330 are not provided so as to avoid redundancy. In some implementations, the lamp cover 340 may be mounted on the holder 320. Alternatively, in implementations in which the LED lighting module 300 does not include the holder 320, the lamp cover 340 may be mounted on the top surface which is located at the first distal end 316 of the monolithic base 310, as shown in FIG. 3.

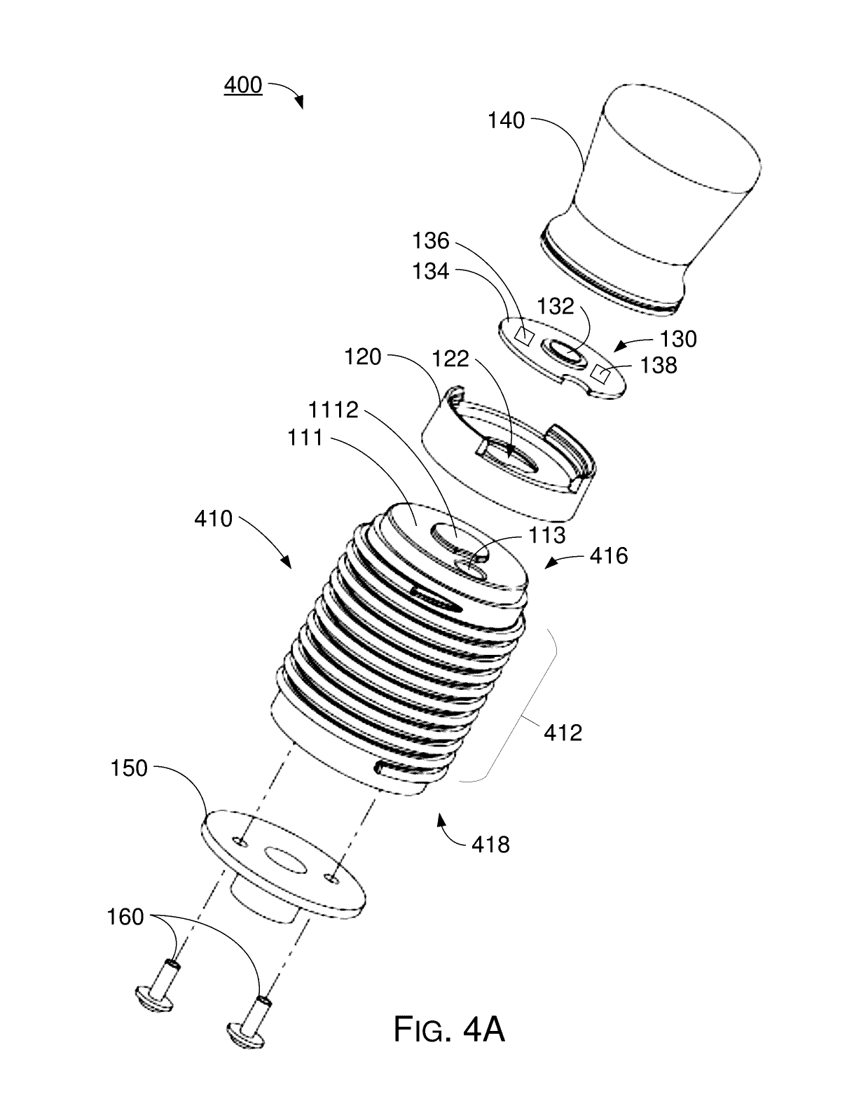

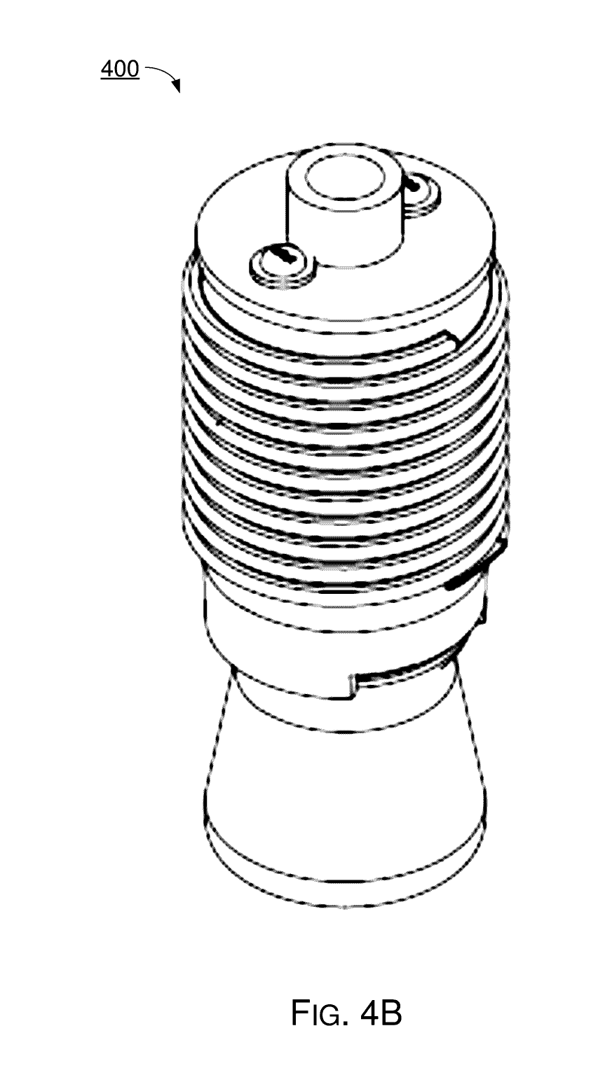

FIG. 4A illustrates an exploded view of an LED lighting module 400 in accordance with another embodiment of the present disclosure. FIG. 4B is a perspective bottom view of the LED lighting module of FIG. 4A. The LED lighting module 400 may be a part of a lamp, and may include a monolithic base 410, a holder 120, an LED lighting member 130 and a lamp cover 140. The holder 120 and the LED lighting member 130 of the LED lighting module 400 are respectively identical to the holder 120 and the LED lighting member 130 of the LED lighting module 100. Therefore, in the interest of brevity, detailed descriptions of elements of the LED lighting module 400 which element symbols are identical to that of the LED lighting module 100 are not provided so as to avoid redundancy. In FIG. 4A, the lamp cover 140 is exemplified as a trapezoid, but alternatively, the lamp cover 140 may be shaped like a bullet or a traditional light bulb. The only one difference between the LED lighting module 100 and the LED lighting module 400 is that the monolithic base 410 of the LED lighting module 400 includes more screw threads 412 which are disposed across the exterior surface between the first distal end 416 and the second distal end 418 of the monolithic base 410. This design of the monolithic base 410 having the screw threads 412 across the exterior surface between the first distal end 416 and the second distal end 418 is suitable for engaging with different lampshades which have various depths or various heights. In other words, different sizes of distribution area of the screw threads of the monolithic base are adapted for engaging with different lampshades having various depths or heights.

In accordance with another embodiment of the present disclosure, a lamp (not shown) is also disclosed. The lamp includes a lampshade (not shown) and an LED lighting module, wherein the LED lighting module may be the LED lighting module 100, the LED lighting module 200, the LED lighting module 300, or the LED lighting module 400. The abovementioned lampshade includes an accommodating space and at least one first opening, wherein the accommodating space is adapted to accommodate the LED lighting module, the first opening is adapted to allow the LED lighting module to pass through therein and to be accommodated in the accommodating space. And, various design of the monolithic base of the LED lighting modules which have different sizes of distribution area of the screw threads, are adapted for engaging with different lampshades having various depths or heights. In other embodiments, the lampshade may include a second opening corresponding to the first opening, or may include a transparent or translucent top surface corresponding to the first opening, such that light emitted by the light source 132 may transmit through the second opening or the top surface. The abovementioned depth or height means a distance between the first opening and the second opening, or a distance between the first opening and the top surface.

It is worth mentioning that the LED lighting module or the lamp disclosed in the present disclosure can emit light by directly connecting to a power supply without connecting to an extra lamp socket having electric circuits. So the lamp and the LED lighting module disclosed in the present disclosure have a simplified structure and lower costs. The LED lighting module or the lamp disclosed in the present disclosure can be dimmable or non-dimmable.

### Additional Notes

The actual design and implementation in accordance with the present disclosure may vary from the examples described herein. Those ordinarily skilled in the art may make various deviations and improvements based on the disclosed embodiments, and such deviations and improvements are still within the scope of the present disclosure. Accordingly, the scope of protection of a patent issued from the present disclosure is determined by the claims below.

In the above description of exemplary implementations, for purposes of explanation, specific numbers, materials configurations, and other details are set forth in order to better explain the present disclosure, as claimed. However, it will be apparent to one skilled in the art that the claimed subject matter may be practiced using different details than the exemplary ones described herein. In other instances, well-known features are omitted or simplified to clarify the description of the exemplary implementations.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should substantially be construed to mean “one or more,” unless specified otherwise or clear from context to be directed to a singular form.

For the purposes of this disclosure and the claims that follow, the terms “coupled” and “connected” may have been used to describe how various elements interface. Such described interfacing of various elements may be either direct or indirect.

What is claimed is:

1. A light-emitting diode (LED) lighting module, comprising:
an LED lighting member, configured to emit light and comprising at least one LED; and
a monolithic base that is substantially cylindrically shaped with a cavity therein, the monolithic base comprising:
a first distal end;
a second distal end opposite the first distal end;
a top surface located at the first distal end and comprising a hole intercommunicating with the cavity,
wherein the LED lighting member is disposed on the top surface; and
an exterior surface disposed between the first and the second distal ends and including one or more screw threads thereon.

2. The LED lighting module of claim 1, wherein the monolithic base is made of metal or ceramic.

3. The LED lighting module of claim 1, wherein the exterior surface of the monolithic base further comprises a plurality of fins configured to dissipate heat from the monolithic base, wherein the one or more screw threads are disposed near the first distal end and the plurality of fins are disposed near the second distal end.

4. The LED lighting module of claim 1, wherein the one or more screw threads on the exterior surface are disposed near the first distal end or across the exterior surface between the first distal end and the second distal end of the monolithic base.

5. The LED lighting module of claim 1, wherein the LED lighting member further comprises:
a driver-on-board (DOB), comprising a board and a driver circuit, wherein the at least one LED and the driver circuit are disposed on the board, and wherein the driver circuit is configured to drive the at least one LED.

6. The LED lighting module of claim 5, further comprising:
a holder disposed between the DOB and the top surface of the monolithic base, wherein the holder is made of an electrically-insulating material.

7. The LED lighting module of claim 6, wherein the holder further includes a through hole, wherein the through hole of the holder, the hole of the monolithic base and the cavity of the monolithic base are configured to accommodate one or more electrical components configured to supply an electrical power to the driver circuit of the DOB and the at least one LED.

8. The LED lighting module of claim 1, further comprising:
a lamp cover mounted on the first distal end of the monolithic base.

9. The LED lighting module of claim 6, further comprising a lamp cover mounted on the holder.

10. The LED lighting module of claim 9, wherein the lamp cover and the holder respectively includes at least one screw thread or groove, wherein the at least one screw thread or groove of the lamp cover is configured to engage with the at least one screw thread or groove of the holder.

11. The LED lighting module of claim 6, further comprising a locking cap disposed on the holder.

12. The LED lighting module of claim 11, further comprising a lamp cover.

13. The LED lighting module of claim 12, wherein the locking cap comprises more mating threads or grooves, wherein the mating threads or grooves disposed on the locking cap are respectively configured to engage with at least one screw thread or groove on the holder and on the lamp cover.

14. A lamp, comprising:
a light-emitting diode (LED) lighting module, comprising:
an LED lighting member, configured to emit light and comprising at least one LED; and
a monolithic base that is substantially cylindrically shaped with a cavity therein, the monolithic base comprising:
a first distal end;
a second distal end opposite the first distal end;
a top surface located at the first distal end and comprising a hole intercommunicating with the cavity, wherein the LED lighting member is disposed on the top surface; and
an exterior surface disposed between the first and the second distal ends and comprising one or more screw threads thereon; and
a lampshade comprising an accommodating space, wherein the accommodating space is adapted to accommodate the LED lighting module.

15. The lamp of claim 14, wherein the lampshade further comprises at least one first opening configured to allow the LED lighting module to pass through therein and to be accommodated in the accommodating space.

16. The lamp of claim 14, wherein the monolithic base is made of metal or ceramic.

17. The lamp of claim 14, wherein the one or more screw threads of the exterior surface are disposed near the first distal end or across the exterior surface between the first distal end and the second distal end of the monolithic base.

18. The lamp of claim 14, wherein the LED lighting member further comprises:
a driver-on-board (DOB), comprising a board and a driver circuit, wherein the at least one LED and the driver circuit are disposed on the board, and wherein the driver circuit is configured to drive the at least one LED.

19. The lamp of claim 18, wherein the LED lighting module further comprises:
a holder disposed between the DOB and the top surface of the monolithic base, wherein the holder is made of an electrically-insulating material; and
a lamp cover mounted on the holder.
